(19) United States
(12) Patent Application Publication
(10) Pub. No.: US 2003/0065615 A1
(43) Pub. Date: Apr. 3, 2003

(54) Method and terminal device for settlement for short text messages transmitted in telecommunications networks

(76) Inventor: Alexander Aschir, Munchen (DE)

Correspondence Address: Kevin R. Spivak, Morrison & Foerster LLP, Suite 5500, 2000 Pennsylvania Avenue, N.W., Washington, DC, 20006-1888, US

(21) Appl. No.: 10/230,398

(22) Filed: Aug. 29, 2002

(30) Foreign Application Priority Data
Aug. 31, 2001 (DE) 10143725.0

(51) Int. Cl. G06F 17/60

(52) U.S. Cl. 705/39

(57) ABSTRACT

A method and a terminal device for settlement for short text messages transmitted in telecommunications networks. In order to execute flexible and reliable settlement for short text messages, the short text message is transmitted from a short message transmission device to a communication terminal. When the short text message arrives at the communication terminal, a registration process is carried out with suppression of a display of the short message. A settlement message describing the registered short message is transferred from the communication terminal to a settlement unit, and the settlement unit accesses a credit available on the credit account. Upon successful debiting of a short message fee, a success message is transferred to the communication terminal, whereupon the short message can be displayed. Upon failure of the debit, an error message is transferred to the communication terminal, whereupon the display of the registered item of short message remains suppressed.

### CLAIM FOR PRIORITY

This application claims priority to Application No. 10143725.0 which was filed in the German language on Aug. 31, 2001.

### TECHNICAL FIELD OF THE INVENTION

The invention relates to a method and a terminal device for settlement of short text messages transferred in telecommunications networks.

### BACKGROUND OF THE INVENTION

It is generally known for a sender of a short text message to be charged fees for a transfer of the short text message, and e.g. for these to be settled through the sender's telephone bill.

### SUMMARY OF THE INVENTION

The invention discloses a method and a terminal device, with which flexible and reliable settlement of short text messages can be executed in a simple way.

In one embodiment of the invention, a short text message is transferred from a short message transmission device to a communication terminal, when the short text message arrives at the communication terminal a registration process is executed in the communication terminal with suppression of the display of the short message, a settlement message describing the registered short message is transferred from the communication terminal to a settlement unit, which manages a credit account assigned to the communication terminal, the settlement unit accesses a credit available on the credit account, upon successful debiting of a short message fee a success message is transferred to the communication terminal, whereupon the registered short message can be displayed, upon failure of the debit an error message is transferred to the communication terminal, whereupon the display of the registered short message remains suppressed. It is advantageous if the settlement can take place from a prepaid credit account that is assigned to the communication terminal. Need for such settlement of fees at the terminal device arises for example when data incurring costs has been ordered at the terminal from a transmitter of short messages. It is similarly advantageous that the settlement takes place before the short text message is displayed on the receiving communication terminal.

In one aspect of the invention, when the short text message arrives, a display on the communication terminal indicating the arrival of the short message is suppressed. It is preferable that, before settlement of the short text message, an indication that the message has arrived is not output on the communication terminal, so that, for an operator of the communication terminal, the information that a short text message has arrived remains hidden until successful settlement.

According to the invention, data about the sender, the title or the dispatch time of the short message is transferred to the settlement unit with the settlement message.

According to the invention, the amount of the short message fee is determined for the individual short message based on the settlement message. With both the development forms previously cited, it is especially advantageous that the settlement unit is given data about the short text message (sender, title and/or dispatch time), and that the settlement unit can determine the short message fee for the individual short message by evaluating this data.

The invention can also be executed such that, on receipt of the error message, the short message is deleted from the communication terminal. It is advantageous that, after the deletion of the short message, it no longer blocks any resources on the communication terminal.

According to the invention, the invention can also be performed such that data about the failure of the debit is transferred with the error message to the communication terminal, and the data is output from the communication terminal. It is also advantageous that a user of the communication terminal is informed about the failure of the debit attempt, so that he can then take action (e.g. paying a sum of money into the credit account) to enable later debit attempts to be successful.

In another embodiment of the invention, the telecommunications network determines whether the credit account suitable for debiting is assigned to the communication terminal, and the short message is transferred to the communication terminal if the credit account is available. It is advantageous if a suitable credit account is not available for debiting, the short message is not transferred to the communication terminal, and the network resources are thereby not unnecessarily burdened.

In another embodiment of the invention, a service control point of a telecommunications network has an Intelligent Network (IN) structure used as a settlement unit. Since telecommunications networks are often in the form of intelligent networks, it is advantageous to use as the settlement unit a service control point that is present in such intelligent networks, as in this case no additional settlement unit is needed.

The method according to the invention can also be carried out in such a way that a USSD string is transmitted as the settlement message, success message and/or error message.

In another embodiment of the invention, the transfer from the communication terminal of the settlement message and evaluation at the communication terminal of the success message or error message are carried out using data stored on a SIM card in the communication terminal. The storage on a SIM card in the communication terminal of the data needed for the transfer and the evaluation has the advantage that, when the telecommunication terminal is changed, the data is also available on the new communication terminal by simply replacing the SIM card, when the SIM card is inserted in a slot in the new communication terminal.

In still another embodiment of the invention, there is a communication terminal with a short message receiving device for receiving short messages transferred from a short message transmission device, a control device assigned to the short message receiving device, with which the display on the communication terminal of incoming short text messages can be suppressed or executed, a settlement message transmission device, which transfers to a settlement unit a settlement message describing the incoming short message, a receiving device for receiving success messages and error messages from the settlement unit, the success messages occurring for a successful debit of a short message fee from a credit account assigned to the communication terminal and the error messages occurring upon failure of a debit of a short message fee from the credit account, and an evaluation device, which, when a success message occurs, prompts the control device to let the corresponding short text message be displayed, and which, when an error message occurs, prompts the control device to suppress the display of the corresponding short text message. When this communication terminal is used, short text messages can advantageously be settled from a prepaid credit account, the settlement taking place before the short text messages are displayed on the communication terminal.

### BRIEF DESCRIPTION OF THE DRAWINGS

For further description of the invention,

FIG. 1 shows a schematic representation of an embodiment according to the invention.

FIG. 2 shows an embodiment according to the invention and of the communication terminal according to the invention.

### DETAILED DESCRIPTION OF THE PREFERRED EMBODIMENTS

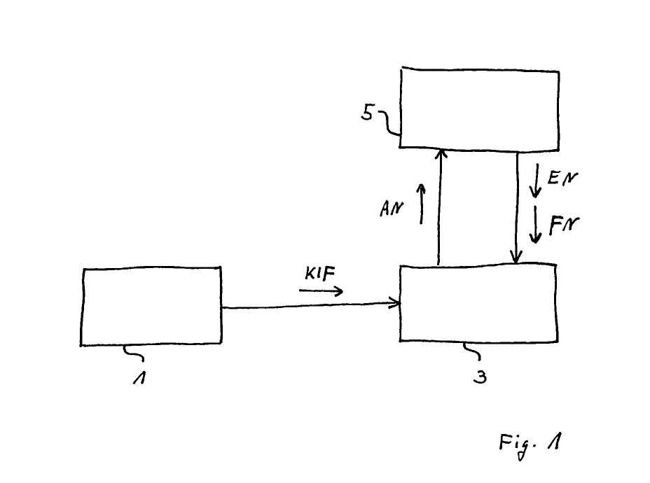

FIG. 1 shows a short message transmission device 1, from which a short message KIF is transferred to a communication terminal 3. One example of the sending of such short text messages in telecommunications networks is the so-called SMS=Short Message Service, in which written items of text information called short messages (SM) are sent to mobile telephones. The short message transmission device 1 may for example be a mobile telephone, a personal computer, a laptop, a digital assistant (PDA=Personal Digital Assistant) or a palmtop. The communication terminal 3, to which the short text message is transferred, may be for example a mobile telephone or else a laptop with a radio interface. The short text message KIF is registered on arrival by the mobile communication terminal 3, but neither the short text message KIF itself nor a indication of its arrival is displayed on the mobile telephone 3. Instead, a settlement message AN is transferred to a settlement unit 5 of the telecommunications network. The settlement unit 5 of the telecommunications network manages a credit account assigned to the communication terminal 3, the account having a prepaid credit balance that can be used for making use of telecommunications services by means of the communication terminal 3. Procedures with such credit accounts are also called “Prepaid Services” (PPS).

Along with the settlement message AN, the settlement unit 5 receives the information that it should pay for the short text message KIF by debiting a short message fee from the credit account managed by the settlement unit 5. If this debit is successful (because the credit account has appropriate cover, i.e. a corresponding credit), the settlement unit 5 sends a success message EN to the mobile telephone 3. On receipt of the success message EN, the mobile telephone 3 lifts the display suppression for the short message KIF, and a user of the mobile telephone 3 can read the short text message on a display on the mobile telephone 3. However, if the debit fails (e.g. because the credit account does not have sufficient credit) , the settlement unit 5 sends an error message FN to the communication terminal 3. The communication terminal 3 thereupon deletes the received short text message KIF, and this is consequently not subsequently shown on the display of the communication terminal 3.

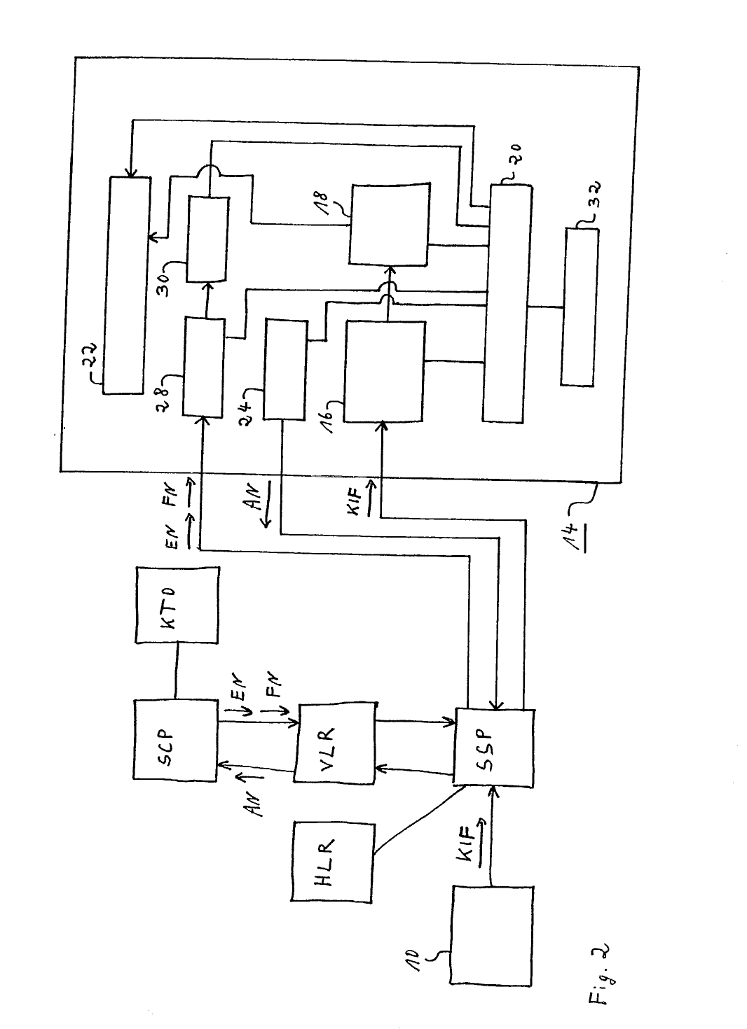

With the help of FIG. 2, an embodiment of the method according to the invention and of the communication terminal according to the invention will now be further described. From a short message transmission device 10, a short text message KIF is transferred through a switching center SSP to a communication terminal in the form of a mobile telephone 14. The switching center SSP is part of a telecommunications network which has an Intelligent Network (IN) structure. In this intelligent network, the switching center SSP acts as a service switching point (SSP=Service Switching Point). From the service switching point SSP, the short text message KIF reaches a short message receiving device 16 in the mobile telephone 14. After its arrival, the short text message KIF is registered in the short message receiving device 16 and stored in a memory 18. A control device 20 ensures that neither the short text message KIF itself nor any indication of its arrival is displayed on a display 22 on the mobile telephone 14. Instead, a settlement message AN is generated in the mobile telephone 14, containing data about the registered short message KIF. This data could be the sender, the title or the dispatch time of the short message, for example. From a settlement message transmission device 24, the settlement message AN is sent through the service switching point SSP and through a visitor location register VLR assigned to this service switching point, to a service control point SCP of the intelligent network IN. Any messages that can transfer the data about the short message can be sent as the settlement message AN; one example of such a settlement message AN is a USSD string. Such a USSD string can have the following format, for example: “*1 2 3 # Stock Info Ltd # 08-20-2001 1713 # Current prices #”. The character string “1 2 3” here, is a so-called “function code”, which identifies the USSD string as a settlement message; “Stock Info Ltd” is the sender of the short message, “08-20-2001 1713” is the date and time data (Aug. 20, 2001, 17:13) and “Current prices” is the title of the short message.

The service control point SCP acts as a settlement unit for the mobile telephone 14, and manages a credit account KTO assigned to the mobile telephone 14. Using the data transferred in the settlement message AN for the individual short message, the settlement unit SCP determines the amount of a short message fee with which the account KTO of the mobile telephone 14 is to be debited. A criterion for the amount of this short message fee is the sender of the short message, for instance. A data memory in the service control point SCP may record, for example, that a short message fee of for instance DM 0.50 is debited for the receipt of short messages coming from the market price information provider “Stock Info Ltd”. As a further example, the service control point can record that each weather report short message is settled by a short message fee of for instance DM 1.00. The service control point SCP can for example detect from the title “Weather report for Aug. 20, 2001” that a particular short message is one such weather report short message. In determining the short message fee, the dispatch time of the short message can also be included. Thus for example it can be specified that a short message transmitted shortly after a certain event (e.g. a topical report on a meeting of politicians) is allocated a higher short message fee than a short message about the previous day's news (i.e. less up-to-date data).

Using the data transferred to it with the help of the settlement message AN, the service control point SCP thus determines the amount of the short message fee for the short message KIF, and accesses the account KTO to debit the short message fee from the credit account balance of the credit account KTO. If this debit transaction is successful (because the credit account KTO has appropriate cover), the service control point SCP returns a success message EN through the visitor location register VLR and the switching center SSP to the mobile telephone 14. This success message is received by a receiving device 28 in the mobile telephone 14 and forwarded to an evaluation device 30. This evaluation device 30 confirms that this is a success message and passes on this data to the control device 20. The control device 20 thereupon causes an indication of the arrival of the short message KIF to be displayed on the display 22 of the mobile telephone. A user of the mobile telephone can now indicate by operating the control elements of the mobile telephone that he wants to view the relevant short message. Controlled by the control device 20, the short message KIF is then retrieved from the memory 18 and displayed on the display 22 of the mobile telephone. Alternatively, the short message can also be displayed on the display 22 immediately after the arrival of the success message EN.

However, if the debit of the short message fee from the credit account KTO is unsuccessful (because this account does not have a sufficient credit account balance, for example), the service control point SCP detects this and sends an error message FN through the visitor location register VLR and the switching center 12 to the mobile telephone 14. This error message EN is also received by the receiving device 28 and analyzed by the evaluation device 30. The evaluation device 30 detects that it is an error message and communicates this data to the control device 20. The control device 20 thereupon directs the memory 18 to delete the short message stored there.

With the error message FN, the mobile telephone 14 can also be passed data on why the debit transaction could not be successfully executed. In this case the control device 20 can arrange for this data to be output to the display 22 (“Your prepaid account does not have the necessary cover for receipt of the message “Latest financial data.””). The success message and the error message can also be transmitted for example as USSD strings, any other form of message also being possible provided it is capable of transmitting the necessary data for the mobile telephone 14.

The service switching point SSP can advantageously be configured such that it forwards to the mobile telephone 14 only the short message KIF transferred to it from the short message transmission device 10, if a credit account KTO assigned to the mobile telephone 14 exists, from which the short message fee can be debited. The service switching point SSP can detect this by retrieving from a home location register HLR the data as to whether the mobile telephone 14 for instance subscribes to the so-called PPS=Prepaid Service: a service that is offered in intelligent networks and enables credit accounts to be used. Such subscription data is stored in the individual subscribers' data in the home location register HLR (e.g. as an identifier in the form of a “ServiceClassMark” (SCI) or a “CamelServiceinformation” (CSI) for the so-called “CAMEL subscription”). This subscription data can also be used by the service switching point SSP to forward the settlement message AN, e.g. in the form of a USSD string, to the service control point SCP responsible for the mobile telephone.

The data needed for operation of the control device 20 of the mobile telephone 14 can be stored, for instance, on a SIM card 32 (SIM=Subscriber Identity Module). This data can be represented by programmable software on the mobile telephone (so-called SIM toolkit).

In the described solution according to the invention it is advantageous if there is flexible charging for different short text messages can be implemented with regard to the size of the fee to be debited. It is likewise preferable that the short message arrives at the receiver before the short message fee is settled from the credit account. The method according to the invention can be integrated without problems in existing GSM mobile radio networks (GSM=Global System for Mobile Communication), since the processes customarily used for the short message traffic are not disrupted by the method according to the invention. It is simply necessary to adapt the home location register HLR such that it stores the data that a mobile telephone 14 subscribes to a service (e.g. IN service) for the settlement of short text messages. For mobile telephones not subscribing to this service, no additional traffic load arises in the telecommunications network, as no short text messages are forwarded by the switching center 12 to such mobile telephones. The system establishes at the time the short message occurs whether the destination mobile telephone has a (prepaid) credit account, and how this account can be accessed.

What is claimed is:

1. A method for settlement for short text messages transferred in telecommunications networks, comprising:
transferring a short text message from a short message transmission device to a communication terminal;
performing a registration process when the short text message arrives at the communication terminal, in the communication terminal, with the display of the short message being suppressed;
transferring a settlement message describing the registered short message from the communication terminal to a settlement unit, which manages a credit account assigned to the communication terminal;
accessing a credit available on the credit account via the settlement unit;
transferring a success message upon successful debiting of a short message fee to the communication terminal, whereupon the registered short message is displayed; and
transferring an error message to the communication terminal upon failure of debit, whereupon the display of the registered short message remains suppressed.

2. The method as claimed in claim 1, wherein when the short text message arrives, a display on the communication terminal indicating the arrival of the short message is suppressed.

3. The method as claimed in claim 1, wherein data about a sender, a title or a dispatch time of the short message is transferred to the settlement unit with the settlement message.

4. The method as claimed in claim 1, wherein an amount of the short message fee is determined for the individual short message based on the settlement message.

5. The method as claimed in claim 1, wherein on receipt of the error message, the short message is deleted from the communication terminal.

6. The method as claimed in claim 1, wherein data about failure of the debit is transferred with the error message to the communication terminal, and the data is output from the communication terminal.

7. The method as claimed in claim 1, wherein the telecommunications network determines whether the credit account for debiting is assigned to the communication terminal, and the short message is transferred to the communication terminal if the credit account is available.

8. The method as claimed in claim 1, further comprising:
a service control point of a telecommunications network having an Intelligent Network structure and is used as the settlement unit.

9. The method as claimed in claim 1, wherein a USSD string is transferred as the settlement message, success message and/or error message.

10. The method as claimed in claim 1, wherein the transmission at the communication terminal of the settlement message and an evaluation at the communication terminal of the success message or error message are carried out using data stored on a SIM card of the communication terminal.

11. A communication terminal, comprising:
a short message receiving device to receive short text messages transmitted by a short message transmission device;
a control device assigned to the short message receiving device, with which a display on the communication terminal of incoming short text messages can be suppressed or executed;
a settlement message transmission device, which transfers to a settlement unit a settlement message describing the incoming short message;
a receiving device to receive success messages and error messages from the settlement unit, the success messages occurring for a successful debit of a short message fee from a credit account assigned to the communication terminal and the error messages occurring upon failure of a debit of a short message fee from the credit account; and
an evaluation device, which, when a success message occurs, prompts the control device to allow the corresponding short text message to be displayed, and which, when an error message occurs, prompts the control device to suppress the display of the corresponding short text message.
